(19) United States
(12) Patent Application Publication
(10) Pub. No.: US 2006/0205512 A1
(43) Pub. Date: Sep. 14, 2006

(54) Game system

(76) Inventors: Atsushi Watanabe, Tokyo (JP); Jinichiro Okuda, Tokyo (JP); Junichi Tsuchiya, Tokyo (JP)

Correspondence Address: DICKSTEIN SHAPIRO LLP, 1825 EYE STREET NW, Washington, DC, 20006-5403, US

(21) Appl. No.: 11/345,283

(22) Filed: Feb. 2, 2006

(30) Foreign Application Priority Data
Feb. 16, 2005 (JP) 2005-38595

(51) Int. Cl. A63F 13/00

(52) U.S. Cl. 463/42

(57) ABSTRACT

A game device totals the circumstances of competition between users in each phase, and obtains the number of competitions being held in the phase. When the number of competitions obtained is smaller than the number of competitions which can be processed at once by the game device, the game device has surplus calculation capacity. In this case, the game device transmits a game request signal, together with information to specify the difference between the number of competitions which can be processed at once and the obtained number of competitions, to a server. The server receives the game request signal, and if there is information relating to unprocessed competitions, transmits this information to the game device which has transmitted the game request signal so as to have the game device perform the processing.

### BACKGROUND OF THE INVENTION

1. Field of the Invention

The present invention relates to a game system comprising a game device which processes a computer game having a gaming element in which a player, as a manager who leads a team made up of a plurality of team members, manages competition with another team by selecting team members to participate from among team member candidates, as well as to a game device, game data processing method, and game program.

2. Description of the Related Art

A computer-controlled arcade games arranged in amusement arcades in towns, game corners in amusement parks and other areas are quite diverse, and range from a single game device played by a single player, to a single game device played by a plurality of players. For example, a number of stores provide game devices equipped with eight seats, with input buttons and keys and an output display for each seat, so that eight persons can play at one of the game devices. As a consequence, there are stores with favorable locations at which users fill all eight seats, and stores at which, depending on the time of day and day of the week, seats are empty, as well as stores at which only one or two seats are filled up in each time. Thus there is difference in the operating status of game devices in different stores.

Normally, the game devices in each store function independently, and do not operate in concert. The game device such as that of the above example, no matter in where store it is placed, has the processing capacity necessary when all eight seats are occupied by users; but if there is difference in the operating status, this processing capacity cannot be utilized effectively.

In the technology of the prior art, there has been a tendency to make efficient use of the surplus resources of computer. For example, in Japanese Patent Laid-open No. 2002-269394, a distributed processing intermediary system is disclosed which comprises a distributed processing capacity supply terminal which an information processing capacity remains, a distributed processing consignment terminal which consigns distributed processing, and a distributed processing intermediary server which intermediates therebetween.

However, in the technology of the prior art, it is necessary to register the contents of the processing consigned by the consigning side, or to register the contents of the processing which can be entrusted by the entrusting side, or to bring both into conformity. In order to perform such procedures, the number of communication lines between the entrusting-side terminal and the consigning-side terminal (or the intermediary terminal) must be increased, and it may be necessary to provide an environment which each of the terminal is connected in each other constantly.

Further, depending on the game, it may be sufficient merely to modify the conditions (for example, parameter values) to use the same algorithm for game internal processing. For example, when performing processing for a match in a soccer game, if parameter values are provided to specify the weather, the location at which the match is held, the participating athletes, and similar, then in some cases the same algorithm can be used to perform calculations relating to a match which is reproduced in the game. In this case, registration upon each instance and similar is unnecessarily troublesome, and so introduction of the technology of the prior art has been difficult.

### SUMMARY OF THE INVENTION

An object of this invention is to provide a game system, game device, game data processing method, and game program, which can realize simply a method for efficiently utilizing surplus processing capacity in a game device.

The above object is attained by providing a game system which, according to a first aspect of the invention, is a game system having a plurality of game devices each of which processes a computer game having a gaming element in which a player, as a coach who leads a team composed of a plurality of team members, manages competition with another team by selecting team members to participate from among team member candidates, and a server connected to the plurality of game devices via a network to enable transmission and reception of information, and characterized in that the game devices each has a plurality of input and output sets in each of which an input portion into which instruction for the computer game is input is paired with an output portion on which game image relating to the computer game is displayed, a storage portion in which is stored in advance a first control program to cause display, on the output portions, of the game images, and a control portion which reads the first control program from the storage portion of the game device and performs processing for a prescribed number of competitions; by executing the first control program, the control portion of the game device having an entry acceptance portion which periodically sets an acceptance interval and accepts competition request signal input via an input portion from the player during the acceptance interval, a competition number decision portion which decides the number of competitions based on the competition request signal, a server query portion which, when the difference between the prescribed number of competitions which the control portion is capable of processing and the competition number thus decided is one or greater, transmits to the server a game request signal together with information specifying the difference, a seed data generation portion which, based on team member information specifying members of a team to be led by each player input via the input portion, generates seed data necessary for display, as game image, of a circumstance of the competition corresponding to the competition request signal, a competition image processing portion which generates the game images based on the seed data and displays the images on the corresponding output portion, and a server notification portion which, when the server responds to a game request signal transmitted by the server query portion, processes the competition corresponding to the response from the server based on team member information received as the response, and transmits to the server processing result information having information identifying the winning team in the competition assigned by the server; the server has a storage portion which stores in advance team member information relating to a plurality of teams and a second control program, and a control portion which reads and executes the second control program; and, by executing the second control program, the server control portion having a competition generation portion which generates a combination of teams to be made to compete from the plurality of teams relating to the team member information stored in advance in the server storage portion, and stores in the server storage portion the combination generated for each competition, associated with the team member information of the corresponding teams, a competition assignment portion which, upon receiving the game request signal and an information specifying a difference from the server query portion, if an unprocessed competition exist among the generated competitions, responds to the game device which has transmitted the game request signal with team membership information associated with the unprocessed competitions of the competitions corresponding to the difference, and a result acquisition portion which associates processing result information transmitted by the server notification portion with the generated competition and stores the result information in the storage portion.

According to a preferred embodiment of the above aspect of the invention, the competition generation portion implements a tournament match by generating the combination of teams to be caused to compete from among a plurality of winning teams acquired by the result acquisition portion. According to a preferred embodiment of the above aspect of the invention, the control portion of the game devices, by executing the first control program, having a winning team notification portion which transmits to the server the team member information of the winning team in a specific competition, among the plurality of competitions being held in the game device; and the team member information for the plurality of teams stored in advance in the storage portion of the server is the team member information transmitted by the winning team notification portions of the plurality of game devices.

According to a preferred embodiment of the above aspect of the invention, the storage portion of the game devices further stores an identifier which identifies the game device; the winning team notification portions transmit to the server the team member information for winning teams associated with the identifier; the control portion of the game devices, by executing the first control program, further having a broadcast request portion, which transmits to the server, together with the game device identifier, a broadcast request signal to display the competitions of winning teams produced in the game device; and, the control portion of the server executes the second control program to further having a broadcast information response portion which, upon reception of the broadcast request signal, identifies teams associated with identifiers which have also been received, references the storage portion of the server and selects competitions containing the identified teams, and transmits, as a response to the game device which has transmitted the broadcast request signal, the opposing teams to compete in the selected competition and team member information for the two identified teams.

According to a preferred embodiment of the above aspect of the invention, the game devices further have, in addition to the output portions included in the input and output sets, a large-size display device; and when the server responds to the broadcast request signal of the broadcast request portion, the competition image processing portion displays, either on the large-size display device or on the output portion included in the input and output set not being used in competition between players among the input and output sets, the game images generated based on the team member information received as the response. Further, according to a preferred embodiment of the above aspect of the invention, the competition assignment portion transmits to a plurality of game devices the team member information relating to the same competitions, and the result acquisition portion, upon receiving the same processing result information from at least two game devices among the plurality of game devices to which team member information relating to the same competitions has been transmitted, stores the processing result information, associated with the generated competition, in the storage portion of the server.

The above object is attained by providing a game data processing method which, according to a second aspect of the invention, is a game data processing method in a game system having a plurality of game devices each of which process a computer game having a gaming element in which a player, as a coach who leads a team composed of a plurality of team members, manages competition with another team by selecting team members to participate from among team member candidates, and a server connected to the plurality of game devices via a network to enable transmission and reception of information, and in which the game devices each has a plurality of input and output sets in each of which an input portion into which instruction for the computer game is input is paired with an output portion on which game image relating to the computer game is displayed; and is characterized in that each game device periodically sets an acceptance interval, accepts a competition request signal input via the input portion from the player during the acceptance interval; based on the competition request signal, the game device decides the number of competitions; when the difference of a prescribed number of competitions which can be processed by the game device minus the number of competitions thus decided is one or greater, the game device transmits a game request signal to the server together with information specifying the difference; the server generates combinations of teams to be made to compete from the plurality of teams relating to the team member information stored in advance in the storage portion of the server, and for each competition generated, stores the team member information for the corresponding teams in association in the storage portion of the server; upon reception from a game device of a game request signal together with information specifying the difference, if an unprocessed competition exist among the generated competitions, the server responds to the game device which has transmitted the game request signal with team member information associated with the unprocessed competitions for the number of competitions corresponding to the difference; and, based on the team member information identifying team members of teams to be led by each player, input via the input portion, the game device generates the game images displaying a circumstance of competitions corresponding to the competition request signal, displays the generated game images on the corresponding output portion, and when there is a response by the server to a competition request signal transmitted by the game device, processes the competition corresponding to the response form the server based on the team member information received as the response, and transmits to the server processing result information having information identifying the winning team of the competition assigned by the server.

The above object is attained by providing a game device which, according to a third aspect of the invention, is a game device which processes a computer game having a gaming element in which a player, as a coach who leads a team composed of a plurality of team members, manages competition with another team by selecting team members to participate from among team member candidates, and is characterized in having a plurality of input and output sets in each of which an input portion into which instruction for the computer game is input is paired with an output portion on which game image relating to the computer game is displayed, a storage portion in which is stored in advance a first control program to cause display on the output portion of the game image, and a control portion which reads the first control program from the storage portion of the game device and performs processing for a prescribed number of competitions; by executing the first control program, the control portion has an entry acceptance portion which periodically sets an acceptance interval and which accepts a competition request signal input via the input portion from the player during the acceptance interval, a competition number decision portion which decides the number of competitions based on the competition request signal, a server query portion which, when the difference between the prescribed number of competitions which the control portion is capable of processing and the competition number thus decided is one or greater, transmits to the server via the game device and a network a game request signal together with information specifying the difference, a seed data generation portion which, based on team member information identifying members of a team to be led by each player input via the input portion, generates seed data necessary for display, as game image, of the circumstance of competition corresponding to the competition request signal, a competition image processing portion which generates the game images based on the seed data and displays the images on the corresponding output portion, and a server notification portion which, when the server responds to a game request signal transmitted by the server query portion, processes the competition corresponding to the response from the server based on team member information received as the response, and transmits to the server processing result information comprising information identifying the winning team in the competition assigned by the server.

The above object is attained by providing a program which, according to a fourth aspect of the invention, processes a computer game having a gaming element in which a player, as a coach who leads a team composed of a plurality of team members, manages competition with another team by selecting team members to participate from among team member candidates, and causes a game device, having a plurality of input and output sets in each of which an input portion into which instruction for the computer game is input is paired with an output portion on which game image relating to the computer game is displayed, to function as an entry acceptance unit which periodically sets an acceptance interval and accepts a competition request signal input via the input portion from players during the acceptance interval; a competition number decision unit which decides the number of competitions based on the competition request signal; a server query unit which, when the difference between the prescribed number of competitions which the game device is capable of processing minus the competition number thus decided is one or greater, transmits to a server, connected via a network to the game device to enable information transmission and reception, a game request signal together with information specifying the difference; a seed data generation unit which, based on team member information identifying members of a team to be led by each player input via the input portions, generates seed data necessary for display, as game image, of the circumstances of competition corresponding to the competition request signal; a competition image processing unit which generates the game image based on the seed data and displays the images on the corresponding output portion; and, a server notification unit which, when the server responds to a game request signal transmitted by the server query unit, processes the competition corresponding to the response from the server based on team member information received as the response, and transmits to the server processing result information including an information identifying a winning team in the competition assigned by the server.

The above object is attained by providing a game data processing method which, according to a fifth aspect of the invention, processes a computer game having a gaming element in which a player, as a coach who leads a team composed of a plurality of team members, manages competition with another team by selecting team members to participate from among team member candidates, in a game device, having a plurality of input and output sets in each of which an input portion into which instruction for the computer game is input is paired with an output portion on which game image relating to the computer game is displayed; and is characterized in that the game device periodically sets an acceptance interval and accepts competition request signals input via the input portion from the player during the acceptance interval; the game device decides the number of competitions based on the competition request signal; when the difference between the prescribed number of competitions which the game device is capable of processing minus the competition number thus decided is one or greater, the game device transmits to a server, connected via a network to the game device to enable information transmission and reception, a game request signal together with information specifying the difference; and, based on team member information identifying members of a team to be led by each player input via the input portion, the game device generates game images of the circumstances of competition corresponding to the competition request signal, displays the images on the corresponding output portion, and, when the server responds to a game request signal transmitted by the game device, processes the competition corresponding to the response from the server based on the team member information received as the response, and transmits to the server a processing result information including an information identifying the winning team in the competition assigned by the server.

By means of this invention, a system can be introduced which efficiently utilizes the surplus processing capacity of each game device. This system can be introduced inexpensively and with ease, and does not require additional equipment. That is, the system is expansible without adding new equipment (a server) or incurring added costs. There is no need for the communication lines between the server and the game devices within the system to be in regular use, so that communication costs can also be suppressed even if the system is operated.

### BRIEF DESCRIPTION OF THE DRAWINGS

FIG. 1 shows an example of the configuration of the game system in an embodiment of the invention;

FIG. 2 is a summary view of the game device in an embodiment of the invention;

FIG. 3 is a block diagram of the game device in an embodiment of the invention;

FIG. 4 is a block diagram of the server in an embodiment of the invention;

FIG. 5 is a timing chart showing an example of operation of the game system in an embodiment of the invention;

FIG. 6 is a timing chart showing an example of operation of the server in an embodiment of the invention;

FIG. 7 shows an example of the data configuration in a winning team table;

FIG. 8A and FIG. 8B show examples of the data configuration of competition tables stored in a server;

FIG. 9 is an example of the data configuration of a results table;

FIG. 10 is a flowchart showing an example of operation of a game device during game assignment in an embodiment of the invention;

FIG. 11 shows an example of the data configuration of an entry table;

FIG. 12 shows an example of the data configuration of a local competition table stored in a game device;

FIG. 13 shows an example of the data configuration of an athlete table; and,

FIG. 14 is a function block diagram of the game system in an embodiment of the invention.

### DESCRIPTION OF THE PREFERRED EMBODIMENTS

Below, embodiments of the invention are explained, referring to the drawings. However, the technical scope of the invention is not limited to these embodiments, but extends to the inventions described in the scope of claims, and to inventions equivalent thereto.

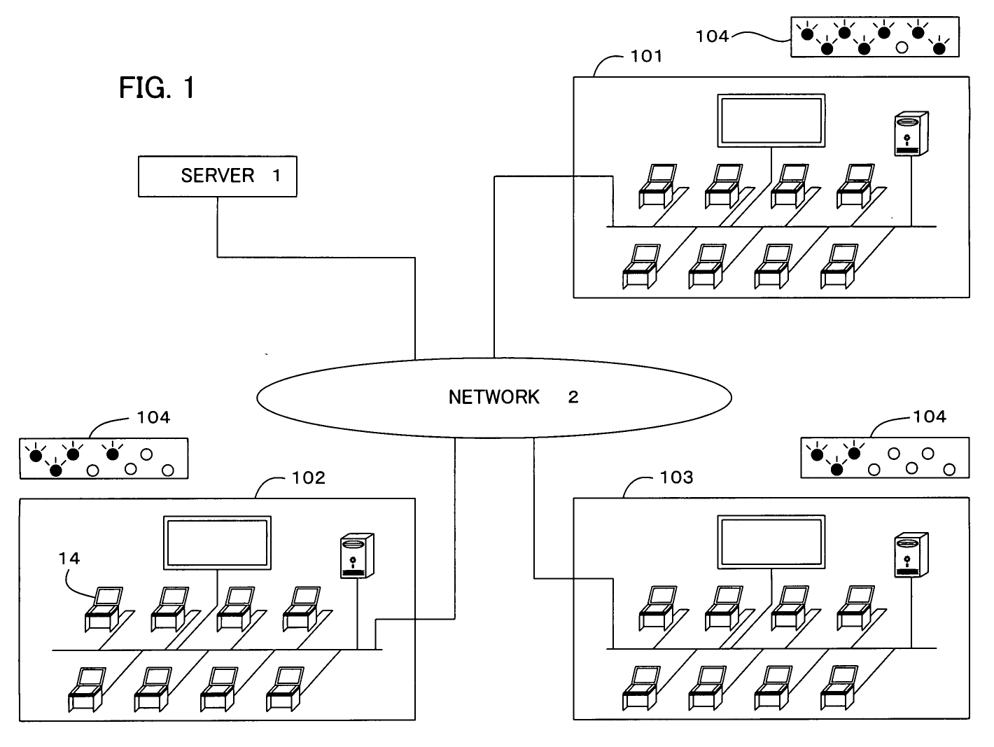

FIG. 1 shows an example of the configuration of the game system of an embodiment of the invention. The game system of this embodiment comprises game devices 101, 102, 103 placed in a plurality of stores, and a server 1 connected to each of the game devices via a network 2.

The game played in this embodiment is a soccer game which uses commercially marketed trading cards. Athlete information is stored on the commercially marketed trading cards. The user becomes a coach, and selects the athletes who will be made to participate in the game (that is, who will be made to anticipate in competition with the computer or in a competition with another user) from among the trading cards the user has purchased in the past.

By purchasing trading cards and the number of cards is increased, or by exchanging trading cards with other users, a user collects athletes who are to participate in games, and can register a lot of athletes on a team. An athlete registered on a team is stored in an IC card (coach card) prepared separately from the trading cards.

Through input of participating athlete information to the game device, the user can enjoy competition through games. The user can also input strategic instructions relating to the progress of the game, and can input instructions for athlete substitutions according to the condition of the athletes and features of the opposing team. And, by skillfully utilizing opportunities to enhance the capabilities of his team which are provided by winning competitions, the user can further strengthen the team which the user leads.

In FIG. 1, each game device has eight satellite terminals 14, so that eight users can play at once. Each satellite terminal 14 comprises an input and output set in which is a pair of an input portion, for example, keys, buttons, or others, and an output portion, for example, a CRT (Cathode Ray Tube), liquid crystal display, or others. The input portion is further having the function for reading information stored on trading cards (for example, a bar code reader or an IC (Integrated Circuit) tag reader), which the user places on the input portion, so that the user can play the game described above.

In this soccer game, one game, including one competition, is conducted for approximately eight minutes, and when one game ends, the game device recruits participants for the next game during an interval for accepting participants. During the acceptance interval, the user operating the input and output set can select either competition with another user (with play by two persons) or competition with the computer (played by one person); the game device awaits the result of these selections, and performs competition processing all at once.

The user can also participate in a prescribed large-scale event, held by each game device. In this case, the game device selects competition opponents as appropriate from among the users participating in the large-scale event.

A feature of the game system in this embodiment is that, upon performing competition processing by each game device, the game device provides notification of the number of competitions (surplus processing capacity) to the server 1, based on the number of competitions in the one game, and if the server 1 has information relating to unprocessed competitions, the server 1 transmits this information to the game device, and the game device processes the competitions assigned by the server 1 together with the competitions of users playing at the game device, so that the surplus processing capacity of the game device is utilized efficiently. Competitions in the soccer game of this embodiment can be processed if at least data identifying the participating athletes is provided.

For example, if the filled circles (●) in a box 104 associated with game devices in FIG. 1 indicate the number of competitions being processed by the game device, then the server 1 transmits one game's worth of (two teams' worth of) participating athlete information to game device 101, four games' worth of participating athlete information to game device 102, and five games' worth of participating athlete information to game device 103, according to the number of empty circles (◯) indicating vacancies. In addition to participating athlete information, the weather, the stadium in which the game is played, the condition of the athletes, and similar, may also be added to “other information related to unprocessed competitions”.

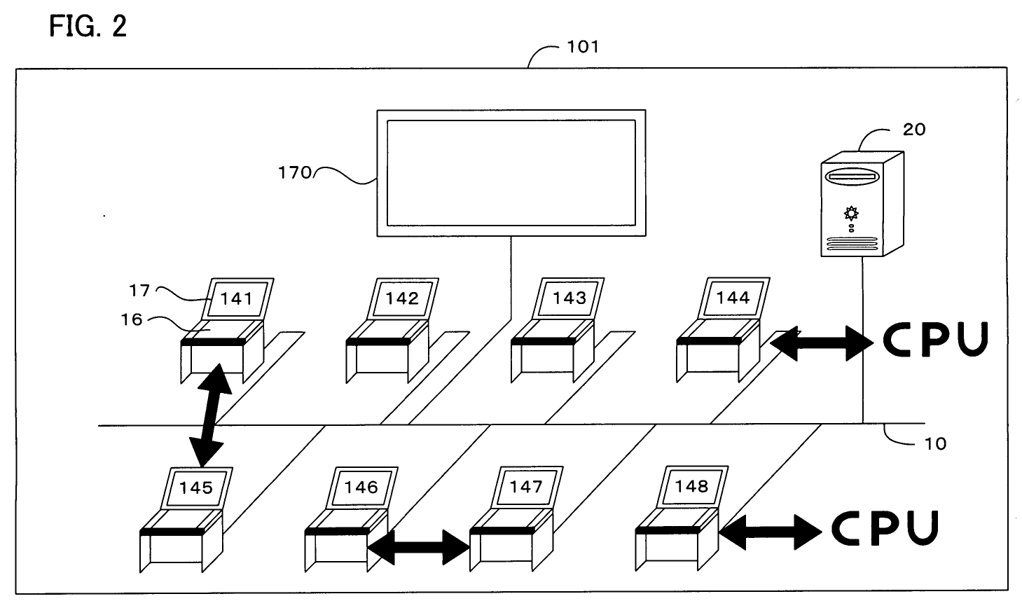

FIG. 2 is a summary view of the game device 101 in this embodiment of the invention. Each of satellite terminals 141 to 148 comprises input and output set 151 to 158, which is a pair of an input portion 16 and an output portion 17. The input and output sets 151 to 158 are interconnected via a bus 10. In addition to the output portions 17 provided in each input and output set, the game device 101 also has a large-size display device 170 which displays instructions to users using the input and output sets, and displays game images to appeal to the audience gathered in the vicinity of the game device 101 during a competition.

The large-size display device 170 is also connected to the bus 10. A PC (Personal Computer) 20 is connected via the bus 10 to the input and output sets 151 to 158 and large-size display 170, and controls these. The PC 20 in this embodiment has the capacity to perform processing for eight games at once, taking into consideration cases in which users have occupied all the satellite terminals 141 to 148 and all desire to compete with the computer.

In FIG. 2, arrows indicate that the user using the satellite terminal 141 is competing with the user using the satellite terminal 145. Similarly, the users using the satellite terminals 146 and 147 are competing with each other. The arrows appearing at the satellite terminals 144 and 148 indicate that these users are not competing against other users, but are competing against the computer (the PC 20). These competitions may be selected by each user, or may be controlled and assigned by the PC 20; this embodiment can be applied to either competition.

In the case of the competitions shown in FIG. 2, overall four games' worth of competitions (the satellite terminals 141 vs. 145, 146 vs. 147, 144 vs. the CPU, and 148 vs. the CPU) are in progress. In this case, the game device 101 can further process four more games' worth of competitions. Thus surplus processing capacity of the game device in each game is requested.

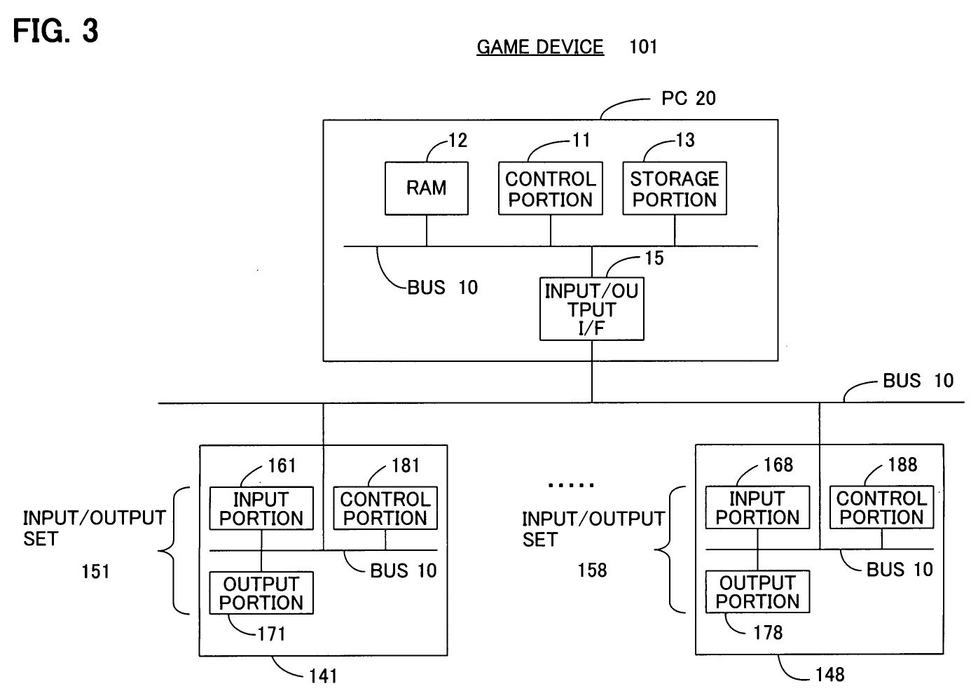

FIG. 3 is a block diagram of the game device 101 in this embodiment of the invention. The game device 101 in FIG. 3 comprises a control portion 11, a RAM (Random Access Memory) 12, a storage portion 13, an input and output interface (I/F) 15, input portions 161 to 168, output portions 171 to 178, and control portions 181 to 188 for each satellite terminal, all interconnected by the bus 10.

The control portion 11 comprises a CPU (Central Processing Unit), and executes a program stored in the RAM 12 to control the various portions comprised by the game device 101. The RAM 12 is storage means in which temporarily stores programs and computation results during processing of the game device 101.

The storage portion 13 is a nonvolatile storage means, such as a hard disk, optical disk, magnetic disk, flash memory, or similar, and stores various data and the game program and similar before being read to RAM 12. The input and output I/F 15 is an interface for connection to the input and output sets 151 to 158 of the game device 101, and may be, for example, a USB (Universal Serial Bus) port or a serial port. The mode of connection to the input and output I/F 15 may be either wireless or by wire.

The input portions 161 to 168 are input devices which inputs input signals for instructions (commands) from the user to the game device 101, for example, game controllers, keyboards, mice, touchscreens, buttons, or other devices. As explained above, the input portions also comprise a function to read trading cards placed on the input portion.

The output portions 171 to 178 are display devices such as liquid crystal displays, CRTs (Cathode Ray Tubes), or other devices to display information to users. In this embodiment, the users sit at satellite terminals and use the eight input and output sets 151 to 158, which pair input portions and output portions, to play the game.

The control portions 181 to 188 of the satellite terminals each includes a CPU (Central Processing Unit), and perform processing to display game images on the output portions of each of the satellite terminals based on seed data to display game images, generated by the control portion 11. Specifically, the control portion 11 of the game device generates, as seed data, position data for objects indicating each of the athletes positioned in a virtual space in the soccer game, position data for the soccer ball object and other data, and outputs this data to the satellite terminals every 1/60 second or every 1/30 second, for example. The control portions 181 to 188 of the satellite terminals perform drawing processing based on the seed data, generate game images every 1/60 second or every 1/30 second, and causes the game images to be displayed on the output portions 171 to 178 of the satellite terminals.

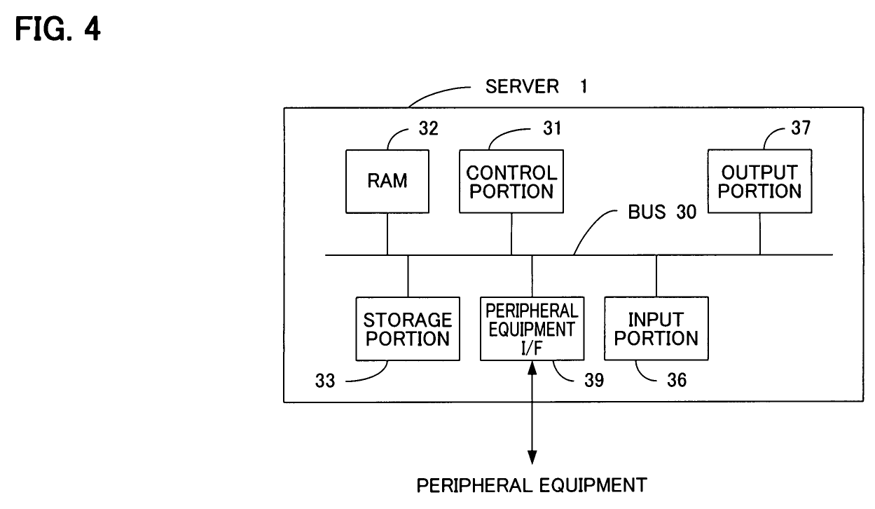

FIG. 4 is a block diagram of the server 1 in this embodiment of the invention. The server in FIG. 4 includes a control portion 31, a RAM (Random Access Memory) 32, a storage portion 33, a peripheral equipment connection interface (I/F) 39, an input portion 36, and an output portion 37, all interconnected by a bus 30. The control portion 31, RAM 32, storage portion 33, input portion 36, and output portion 37 are the same as the control portion 11, RAM 12, storage portion 13, input portion 16, and output portion 17 respectively shown in FIG. 3, and so explanations are omitted.

The peripheral equipment I/F 39 is an interface for connection of peripheral equipment to the server 1, and may be, for example, a USB (Universal Serial Bus) port or a network port. The peripheral equipment may for example include a printer, a SCSI (Small Computer System Interface) equipment, a memory card reader/writer, a wireless LAN equipment, a modem, or similar. The mode of connection to the peripheral equipment via the peripheral equipment I/F 39 may be either wireless or by wire.

The server 1 in FIG. 4 comprises an input portion 36 and an output portion 37; but these may be replaced with an input device or an output device such as a keyboard, a presentation projector, a liquid crystal display, a television, connected externally to the server 1 via the peripheral equipment I/F 39.

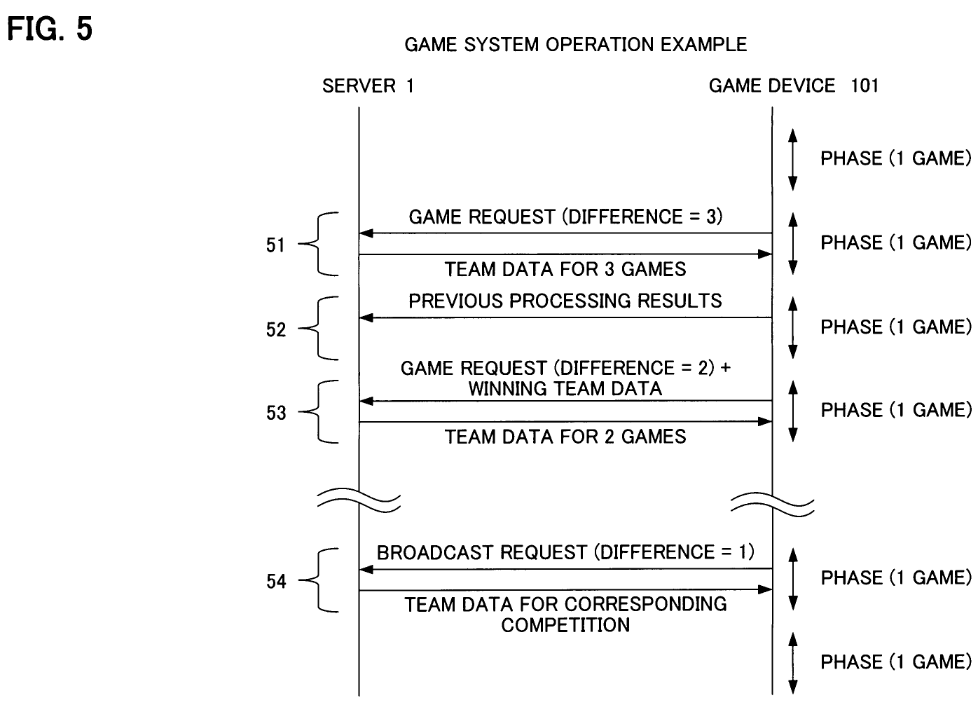

FIG. 5 is a timing chart showing an example of operation of the game system in this embodiment of the invention. In each game device, one game including one competition is repeated for approximately eight minutes. This one game is called a phase in FIG. 15.

The game device 101 of this embodiment totals the competition states between users in each phase, and determines the number of competitions being conducted in the phase. Because the number of competitions which can be processed at once by the PC 20 of each game device is eight, if the number of competitions thus determined is fewer than eight, the game device has surplus processing capacity.

Hence in this case, the game device 101 transmits to the server 1 a game request signal, together with information specifying the difference between the number of competitions which can be processed at once (in the above example, eight) and the number of competitions thus determined. The server 1 receives the game request signal, and if there is the information related to unprocessed games, the server 1 transmits the information to the game device 101 which has transmitted the game request signal information to cause processing by the game device 101.

In the phase 51, the number of competitions processed by the game device 101 is five (when for example five users have each selected to compete with the computer), and so the game device 101 transmits, together with the game request signal, information specifying that the difference (the number of competitions that can be further processed) is three. The server 1 then transmits three games' worth of team data (for six teams). The transmitted team data indicates information to identify the athletes making up each team.

Even when the number of unprocessed competitions remaining on the server 1 is less than the number of competitions which can further be processed by the game device 101 (in the above example, when the server 1 has only two games' worth of data), the server 1 transmits information relating to unprocessed competitions to the game device which has transmitted the game request signal.

The game device of this embodiment transmits processing results for the competitions assigned by the server 1 at the next time of transmission to the server 1. In the case of the game played in this embodiment, if parameter values (athlete information, weather conditions, stadium information, and similar) are given, the competition can be reproduced in the game device 101. As a result, it is sufficient that the processing results transmitted to the server 1 include information specifying the winning team in competitions assigned by the server 1.

In the phase 52, the number of competitions processed by the game device 101 is eight (when eight users have each chosen competition with the computer), and although the game device 101 does not transmit the game request signal, in the phase 51 the game device 101 does transmit three games' worth of processing results, for games assigned by the server 1. The server 1 stores the processing results. The processing results are used in deciding team combinations for new competitions and the ranking of teams in relation to competitions assigned by the server 1.

Further, upon the next transmission to the server 1, the game device of this embodiment transmits team data for the winning teams in the prescribed large-scale event (here assumed to be a store-wide large-scale event) conducted within the game, among the plurality of competitions conducted by the game device. The server 1 then generates new combinations of teams for competition, based on team data for winning teams reported up to a prescribed time, and causes the game device to perform processing for these competitions in the manner described above.

A game system of this embodiment then becomes capable of managing a virtual league (ghost league), in which only the victors of the prescribed large-scale event are assembled. In the ghost league, as opposed to ordinary games held by the game device, victories are determined based only on the team data at the times of victory, without any input of instructions by the user; however, the user can learn the ranking of his own team on a nationwide scale through competition results with winning teams at other stores, gathered over the network 2. This knowledge of his own ranking can serve as a stimulus to the user, motivating the user to fortify his weaknesses and strive for a still higher ranking.

In the phase 53, the number of competitions processed by the game device 101 is six, and so the game device 101 transmits the game request signal together with information indicating that the difference (the number of competitions which can be further processed) is two.

Because the winning teams in the store-wide large-scale event are determined as a result of competitions processed in the preceding phase 52, the game device 101 transmits the team data for the winning teams. The server 1 stores the team data for the winning teams, and transmits two games' worth of team data to the game device 101. The transmitted team data includes information identifying athletes registered with the teams.

Further, rather than the game device of this embodiment processes competitions in order to return the processing results to the server 1, the game device may instead use the surplus processing capacity to display game images in order to captivate new users on unused output portion or on the large-size display 170 in the phase. In this case, if the server 1 transmits team data to the game device, the game device performs calculations related to games based on the transmitted team data, and outputs game images displaying the circumstances of competition to the output portion or similar. If the circumstances of competitions are displayed using the large-size display 170, the atmosphere is as if the game were being broadcasted from another hall, and the user can enjoy the game with the sense that he is present at the contest.

In the phase 54, the number of competitions being processed by the game device 101 is seven, and the game device 101 transmits a broadcast request signal together with information indicating that the difference (the number of additional competitions which can be processed) is one.

The server 1 transmits one game's worth of team data (for two teams), relating to the competition which the game device 101 is caused to display, to the game device 101. The game device 101 displays the circumstances of the competition on the large-size display 170, for example. If there are any vacant output portions, then game device 101 may display this information on those portions as well.

Further, when managing the above-described ghost league, the server 1 identifies the game device which transmits the broadcast request, and can control the team data for transmission to game devices to display the competition of winning team at each game device. For example, if winning team is a team of the store in Tokyo, the server 1 controls such as to broadcast trend for this team, so that the users leading winning teams and their friends can obtain information relating to their own teams at nearby stores.

As explained above, in this embodiment, if there is the request from the game device, the server 1 operates by responding this request. For example, if the server 1 is provided with webserver functions, then the game system of this embodiment can be realized easily and inexpensively.

Further, the server 1 need not constantly monitor or control the states of each game device. Moreover, the number of times communication is performed need only be once in each phase, and the content of the communication need only be text data, so that the amount of data transmitted is not large. Hence there is no need for high-speed communication lines connecting the server 1 and the game devices, and no need for a continuous connection. This fact also contributes to the easy and inexpensive realization of the game system of this embodiment.

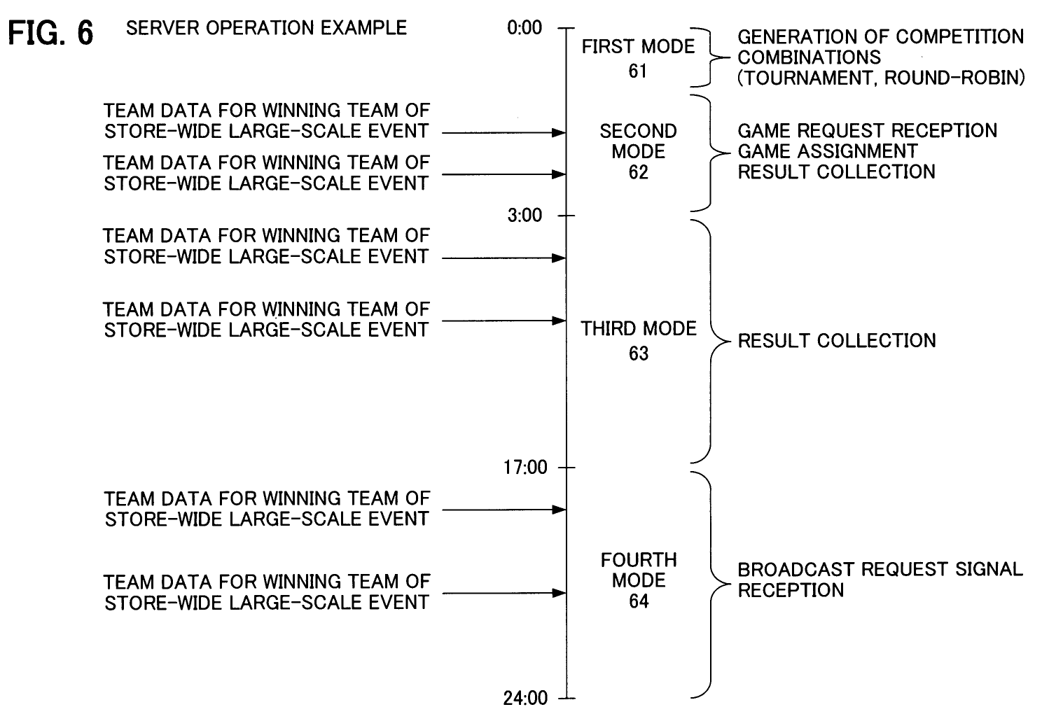

FIG. 6 is a timing chart showing an example of operation of the server 1 managing the ghost league in this embodiment of the invention. An explanation is given for one day's worth along the time axis, but the time shown in FIG. 6 is merely one example.

First, the server 1 in this embodiment awaits team data, for winning teams in store-wide large-scale events in each store, which is transmitted from various game devices as indicated on the left side of the time axis, and stores the data as a winning team table in the storage portion 33 of the server on receiving the team data.

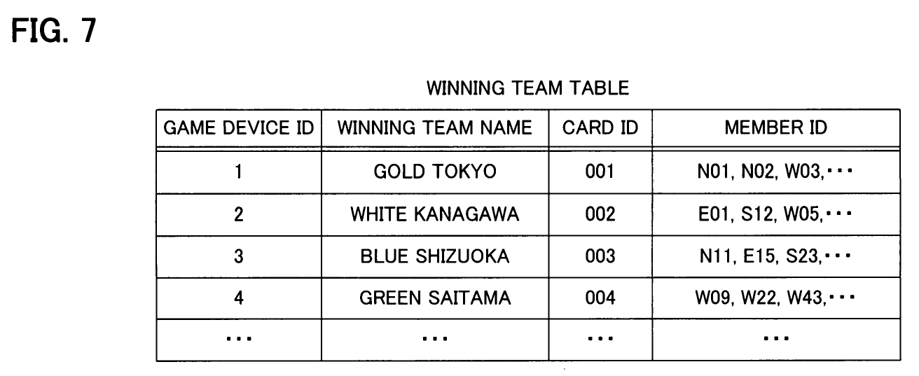

FIG. 7 is an example of the data configuration of the winning team table, including data for the plurality of teams. The winning team table of FIG. 7 contains data fields “game device ID”, “winning team name”, “card ID”, and “member ID”.

Here “game device ID” is an identifier which identifies the game device which has transmitted the winning team of the store-wide large-scale event. The game device is identified by, for example, an IP (Internet Protocol) address, a MAC (Media Access Control) address, an identifier number unique to the terminal (stored for example in the storage portion 13 of the game device in advance), or similar. “Winning team name” is the name of one's own team, assigned by the user at the start of the game.

“Card ID” is an identifier which identifies the coaching card used to store athletes registered with the team. Because the same user may lead a plurality of teams, the card ID is not used to identify the user, but the card ID can be used to identify the team. “Member ID” is a list of athlete IDs identifying athletes registered with the team.

Data for these teams can be collected by which the game device notify the server at the time the game device access the server 1.

Returning to FIG. 6, the server 1 generates combinations of competitions to be assigned to game devices for a prescribed time from 0:00 (first mode 61). Based on the teams containing in the winning team data table (FIG. 7) accumulated up until 0:00, the server 1 generates competition combinations for a tournament or for a round-robin contest.

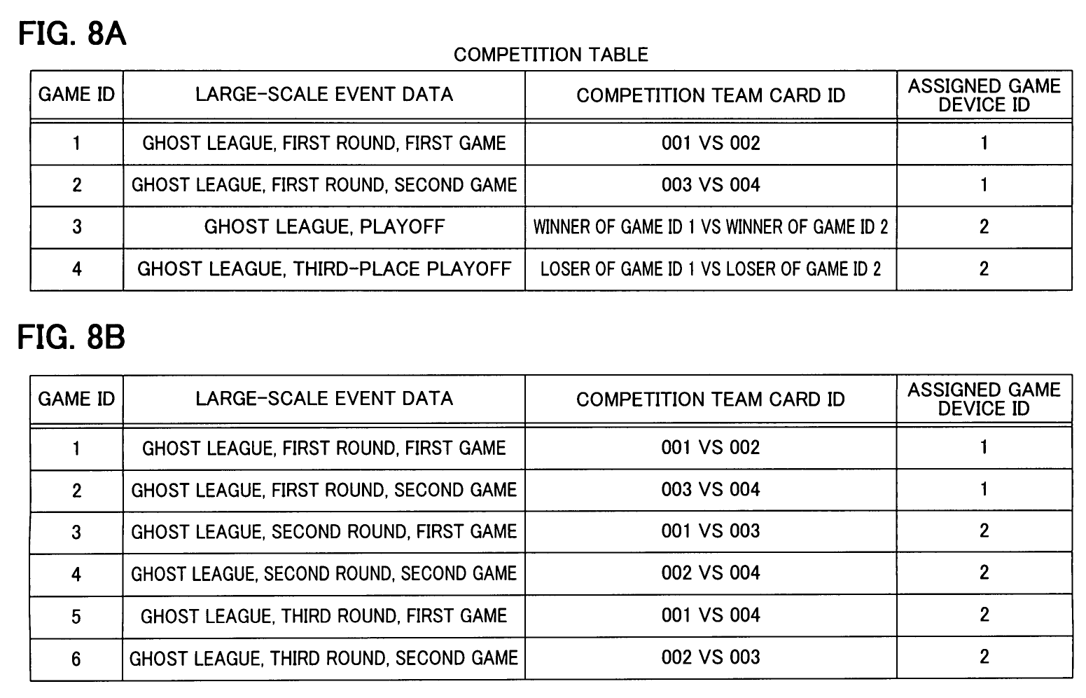

FIG. 8A and 8B show examples of the data configuration of a competition table stored in the server 1. FIG. 8A shows a competition combination when four teams compete in the tournament, and FIG. 8B shows the competition combination when four teams compete in the round-robin contest. The competition tables in FIG. 8 contains data fields “game ID”, “large-scale event data”, “competition team card ID”, and “assigned game device ID”.

The “game ID” is an identifier to identify the game. Different identifiers are allocated to each game. The “large-scale event data” is a name which specifies a number of competitions and game number in the ghost league.

The “competition team card ID” is an identifier to identify the coach card which is in competition. The “assigned game device ID” is a game device ID which identifies the game device to which the generated competition has been assigned. The “assigned game device ID” is initially blank, when the generated competition is assigned, the game device ID of the game device to which the competition has been assigned is stored in this field.

In FIG. 8A, combination is generated for a tournament, in which four teams are divided into two pairs of teams for a first round, the winning teams from the first round then play a playoff, and the losing teams in the first round play a game for third place. In FIG. 8B, combination is generated for a case in which four teams play in a round-robin contest, with each team playing every other team once. The server 1 then can freely generate the competition combination from the winning teams which have been accumulated up to that time.

Competition combination generated in the first mode 61 by the server 1 may also be the form of complicated tournament which includes a consolation match and a seeded team. And, in round-robin contest, a home-and-away format can also be adopted.

Returning to FIG. 6, the server 1 receives game request signals from game devices until 3:00 after completion of generation of competition combinations, and assigns generated competition to game devices as appropriate, as well as receiving processing results for assigned competitions from game devices (second mode 62). As explained in FIG. 5, the server 1 transmits team data registered for corresponding teams to game devices, in order to store processing result for the game device in the storage portion 33, and to assign competitions generated in the first mode 61 to the game device, according to the type of access performed by the game device. Even when the number of unprocessed competitions in the server 1 is less than the number of competitions that can further be processed by the game device 101, the server 1 transmits information relating to the unprocessed competitions to the game device which has transmitted the game request signal.

For example, suppose that the terminal with game device ID of “1” can process two more games' worth of competitions, and the terminal with game device ID of “2” can process five more games' worth of competitions. If the server 1 generates the tournament of four teams as shown in FIG. 8A, then the server 1 assigns two games' worth of processing, with game IDs “1” and “2”, to the terminal with game device ID “1” (at this time, the winner and loser of the game ID “1” are not known, and so processing for games ID “3” and “4” cannot be assigned).

That is, the server 1 transmits the athlete information (the member ID list of FIG. 7) of the team with coach card IDs of “001” and “002” to perform processing of the game with game ID “1”, and the athlete information for the team with coach card IDs of “003” and “004” to perform processing of the game with game ID “2”, to the terminal with game device ID “1”. When the server 1 receives the processing results for the assigned game from the terminal with game device ID “1”, competition processing ends; if the server 1 does not receive the processing results within a prescribed length of time, the server 1 assigns the two games' worth of processing, with game IDs “1” and “2”, to another game device. In this embodiment, the server 1 repeats assignment of competitions until the processing results for the assigned game are received.

As indicated in phase 52 in FIG. 5, the processing result of competitions assigned by the server 1 is transmitted as appropriate from the game device, and the server 1 stores the received processing results in the results table, and updates the victors in the competition table. For example, if the winning team in the game with game ID “1” is the team with card ID “002”, and the winning team in the game with game ID “2” is the team with card ID “003”, then the competition table of FIG. 8A is updated such that the game with game ID “3” (the playoff for the ghost league) is a competition between the teams with card IDs of “002” and “003”, and the game with game ID “4” (the game for third place in the ghost league), is a competition between the teams with card IDs “001” and “004”. If there is new access from the game device in the second mode 62, the server 1 assigns competition with game IDs “3” and “4”, which is an unprocessed competition match, according to the game request signal transmitted from the game device.

A method may also be employed in which the server 1 causes the different game devices to process the same game, and if the results for the same game received from different game devices coincide, the server 1 trusts the result and stores in the results table and also updates the winners in the competition table. If the same processing result is received from the plurality of game devices, the processing result may be a reliable result.

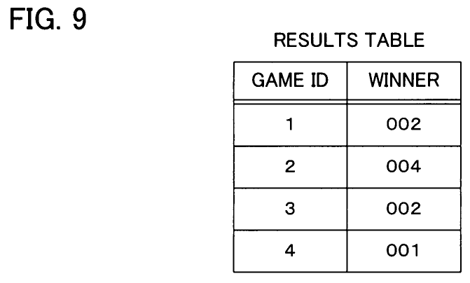

FIG. 9 is an example of the data configuration of a results table, when the tournament competitions of FIG. 8A are executed as the competition combinations. The results table of FIG. 9 contains data fields “game ID” and “winner”.

The “game ID” is an identifier which identifies the game generated by the server 1, and corresponds to the game ID used in FIG. 8. The “winner” is the coach card ID (see FIG. 7) which identifies the winning team in the game.

Returning to FIG. 6, the server 1 completes game assignments by 3:00, and thereafter awaits processing result of the assigned competition from the game device (third mode 63). The server 1 judges whether processing result received is the same, and updates the results table of FIG. 9 and the competition table of FIG. 8A (there are no areas for updating in the competition table of FIG. 8B).

When 17:00 has passed, the server 1 enters broadcast mode (fourth mode 64). Upon receiving the game request signal after 17:00, the server 1 notifies the game device that the server is in broadcast mode. Upon being notified that the server is in broadcast mode, the game device subsequently transmits the broadcast request signal. By this means, the request from game devices can be made to change naturally from game request to broadcast requests, aiming at the time at which people begin to gather at the arcade games. Upon receiving the broadcast request signal, the server 1 judges whether the coach card ID of the teams related to the game device ID, which is also received, is contained in the “winner” column of the results table (FIG. 9). The server 1 first references the winning team table of FIG. 7, and acquires the coach card ID corresponding to the received game device ID. When the coach card ID is included in “winners” in FIG. 9, the server 1 identifies the game ID associated with this “winner”, references the competition table of FIG. 8, and transmits the member ID for the corresponding competition to the game device.

For example, in the case of results such as those shown in FIG. 9, when the terminal with game device ID of “2” transmits the broadcast signal, the server 1 references the winning team table (FIG. 7) and acquires the card ID of “002”. The server 1 references the results table (FIG. 9), finds that this ID is contained in the “winners” column, and identifies corresponding game ID “1” and “3” as broadcast candidate. The server 1 references the competition table of FIG. 8A, and transmits to the game devices the team data of competition corresponding to one of the game IDs of the broadcast candidate.

Next, operation of the game device is explained.

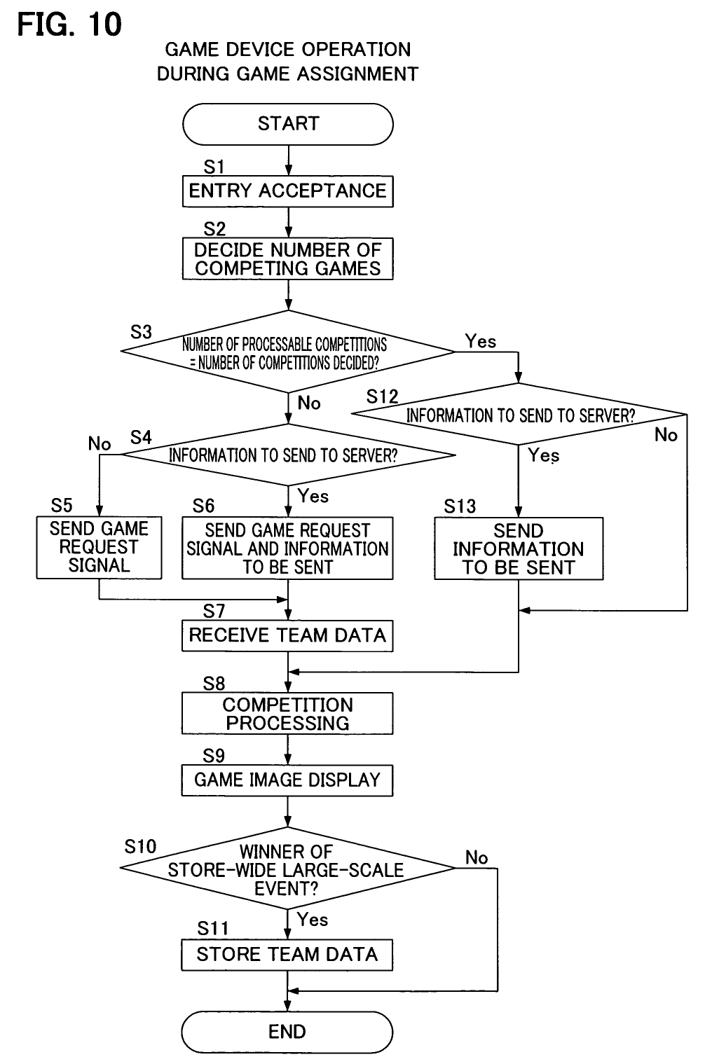

FIG. 10 is a flowchart showing an example of operation (at the time of game assignment) of the game device in different phases of this embodiment of the invention. First the control portion 11 of the game device accepts, for a fixed interval, participation by users who will participate in the game in this phase (S1). Specifically, if each phase lasts approximately eight minutes, then participants are invited during the initial 30 seconds.

When the user participates in the game, the user sits at the satellite terminal, and by inserting a coin or other money into the game device, inputs a usage request signal to the input and output set. The control portion 11 totals these results, and stores the results in RAM 12 as an entry table.

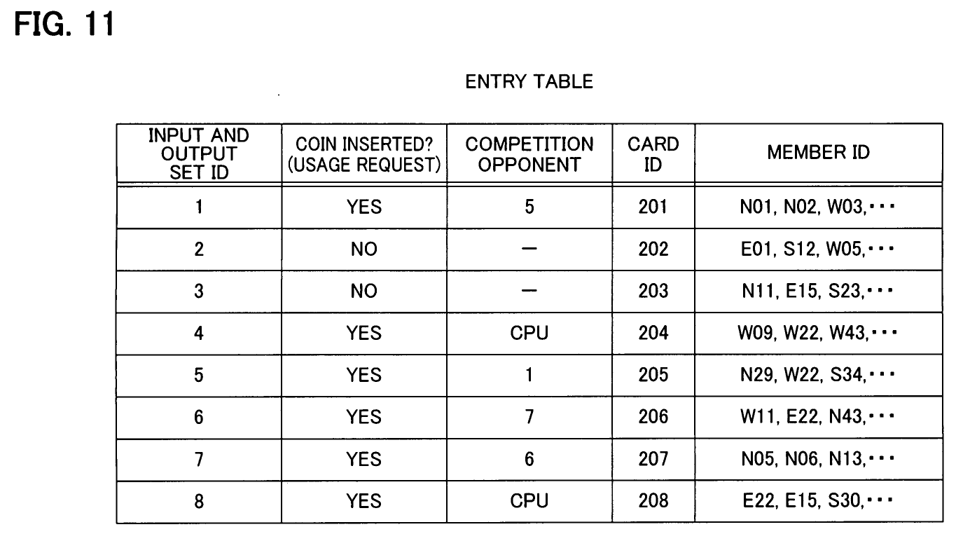

FIG. 11 shows an example of the data configuration of the entry table. The entry table of FIG. 11 contains data fields “input and output set ID”, “coin insertion”, “competition opponent”, “card ID”, and “member ID”.

The “input and output set ID” is a number used to identify the input and output set, eight of which are comprised by one game device of this embodiment. The “coin insertion” is a flag information indicating whether the usage request signal has been input by the user.

The “competition opponent” is an identifier which identifies the input and output set ID of the competition opponent. At the stage of step S1 in FIG. 10, this data field is blank. In a step described below, a value is stored based on a competition request signal input by the user.

The “card ID” is an identifier which identifies the coach card ID of the user. The “member ID” is a list of member IDs which identify the athletes registered on the team led by the user. The “card ID” and “member ID” also have not yet been input and are blank data fields at the stage of step S1 in FIG. 10.

Returning to FIG. 10, the control portion 11 next determines the number of competitive games (S2). The control portion 11, upon receiving the usage request signal from the user, causes a screen to be displayed on the output portions 17 to prompt the users to choose either to compete with another user (two persons play) or to compete against the computer (one person plays), totals the result, and updates the entry table (FIG. 11), while also storing the result in RAM 12 as a local competition table.

That is, when competition with the computer is selected in the “competition opponent” column of the entry table in FIG. 11, the control portion 11 stores “CPU” in the field, and when competition with another user is selected, the control portion 11 stores in the field the input and output set ID which identifies the input and output set of the competition opponent.

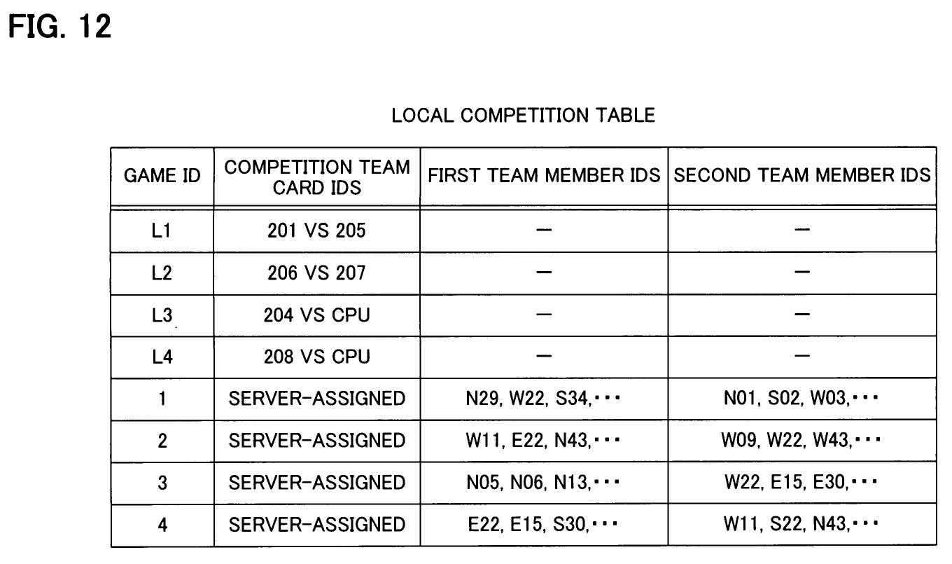

FIG. 12 shows an example of the data configuration of the local competition table stored in a game device. The local competition table of FIG. 12 contains data fields “game ID”, “competition team card ID”, “first team member ID”, and “second team member ID”.

The “game ID” is an identifier to identify the competition processed by the game device. In order to distinguish these from the game IDs used in FIG. 8, the identifier contains an “L”, meaning local, for competitions being processed by the game device. The competition which is counted in the number of competitive games in step S2 is a competition with identifiers including this “L”. The game ID for competition assigned by the server 1 correspond to the game ID used in FIG. 8.

The “competition team card ID” indicates an identifier which identifies the coach cards of two teams which are competition opponents. The “member ID of first team” and “member ID of second team” are lists of member IDs (see FIG. 7) identifying athletes registered with teams in the competition assigned by the server 1. At the stage of step S2 in FIG. 10, these fields are blank.

Returning to FIG. 10, the control portion 11 references the local competition table of FIG. 12 and depending upon how many game IDs which include “L” in the identifier are present, can decide the number of competitive games in step S2. When the processing of step S2 is completed, the control portion 11 checks whether the number of competitions which can be processed by the game device is equal to the number of competitions decided in step S2 (S3). The control portion 11 of this embodiment takes into consideration cases in which users occupy all eight input and output sets and all eight users wish to compete against the computer, and so has the capacity to process eight games at once.

When the number of decided competitions is smaller than the number of competitions which can be processed (No in S3), the game device has surplus processing capacity, and so the game device issues the game request. When competitions have been assigned by the server 1 in the previous phase and the processing results are stored in RAM 12, and when the winning team has emerged in the store-wide large-scale event, the game device must transfer this information to the server 1 in addition to the game request signal. The control portion 11 therefore checks whether there is other information to transmit to the server 1 (S4).

If the RAM 12 is referenced and the above-described data is stored (Yes in S4), the control portion 11 transmits this information with the game request signal to the server 1 (S6). If there is no data in the RAM 12 to be transmitted (No in S4), the control portion 11 transmits only the game request signal (S5). The game request signal transmitted in step S5 or step S6 has added information identifying the difference between the number of competitions which can be processed minus the number of competitions determined in step S2, as information indicating the surplus processing capacity of the game device, and these information are also transmitted.

When the processing of step S5 or S6 is completed, the game device receives the team data transmitted by the server 1 as a response to the game request signal, and the control portion 11 stores the received team data in the local competition table (FIG. 12) (S7). Next, the control portion 11 of the game device processes each of the competitive games based on the team data stored in the local competition table (FIG. 12) (S8).

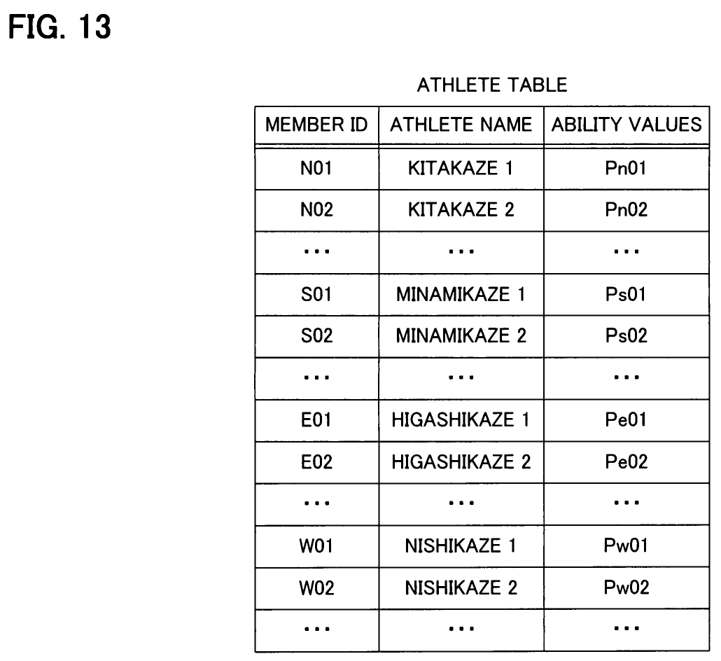

FIG. 13 shows an example of the data configuration of an athlete table used in the competition processing of step S8. The athlete table of FIG. 13 is stored in the RAM 12 of the game device, and contains data fields “member ID”, “athlete name” and “ability values”.

The “member ID” is a number identifying each athlete. The “athlete name” is a name of the athlete. The “ability values” are a list of numerical values indicating, for each athlete, an ability during offensive participation, an ability during defensive participation, a technique, a power, a speed, a stamina, and other characteristics. When performing the competition processing of step S8, the control portion 11 references the athlete table and uses the member IDs provided to expand the ability values of each athlete and perform calculations for competition processing.

Returning to FIG. 10, the game device in this embodiment can process competitions by applying the same algorithm if the parameters have been altered, and so for the competitions assigned by the server 1 performs processing based on the member IDs of the first and second teams in the local competition table (FIG. 12), and for other competitions performs processing based on the member IDs in the entry table (FIG. 11). The processing result for competition assigned by the server 1 is stored in the RAM 12 by the control portion 11, for transmission to the server 1 during the next access.

Next, a processing is performed to display the competition processed in step S8 as game image on the corresponding input and output set (S9). The control portion 11 identifies the corresponding input and output set by referencing the “competition team card IDs” in the local competition table (FIG. 12) and the entry table. The control portion 11 generates, as the seed data, the position data for objects representing each of the athletes placed in the virtual space in the soccer game, the position data for the soccer ball object, and similar, and outputs the seed data to the corresponding satellite terminals every 1/60 second or every 1/30 second, for example. The control portions 181 to 188 of the satellite terminals perform drawing processing based on the seed data, and cause game images to be generated and the displayed on the output portions of the satellite terminals every 1/60 second or 1/30 second.

When, as the result of the competition processing in step S8, the winning team in the store-wide large-scale event is decided (Yes in S10), the control portion 11 stores the team data in the RAM 12 (S11) so as to transmit the data to the server 1 upon the next access, and processing ends.

When in step S3 the number of competitions which can be processed is equal to the number of competitions determined in step S2 (Yes in S3), the game device has no surplus processing capacity and so does not issue the game request. However, if competitions have been assigned by the server 1 in the previous phase and the processing results thereof are stored in the RAM 12, and if the winning team has emerged in the store-wide large-scale event, these information must be transmitted to the server 1. Hence the control portion 11 checks whether there is the information to be transmitted to the server 1 (S12).

The control portion 11 references the RAM 12, and if the above-described data is stored in the RAM 12 (Yes in S12), transmits the information to the server 1 (S13). If there is no data in the RAM 12 to be transmitted (No in S12), the processing of step S13 is omitted. When the processing of step S13 has been completed or if the result in step S12 is No, processing proceeds to step S8.

In step S2 in FIG. 10, the user chooses whether to play against the computer or to compete against another user, but when the game device conducts the prescribed large-scale event within the game, the control portion 11 may make this decision.

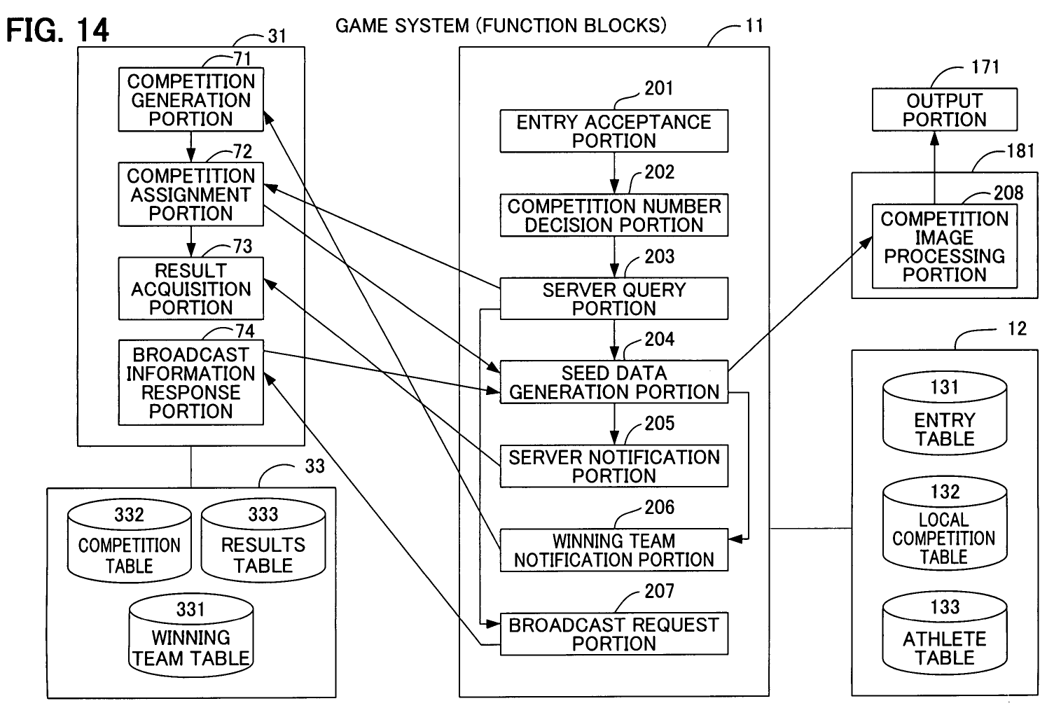

FIG. 14 is a functional block diagram of the game system in this embodiment of the invention. The control portion 11 of the game device comprises an entry acceptance portion 201, a competition number decision portion 202, a server query portion 203, a seed data generation portion 204, a server notification portion 205, a winning team notification portion 206, and a broadcast request portion 207.

The entry acceptance portion 201 periodically sets an acceptance interval, accepts the competition request signal input by the user within an acceptance interval, and updates the entry table 131. The competition number decision portion 202 updates the local competition table 132 and decides the number of competitions based on the competition request signal input by the user during the acceptance interval.

When the difference between the number of competitions which can be processed by the game device minus the number of competitions decided by the competition number decision portion 202 is one or greater, the server query portion 203 transmits to the server 1 the game request signal, together with information indicating this difference. The seed data generation portion 204 references the athlete table 133 stored in the RAM 12 and acquires physical ability parameters for each athlete, based on the member IDs which identify athletes of the team led by each user.

The seed data generation portion 204 then processes the competition corresponding to the competition request signal, and generates the seed data necessary to display, as game images, the circumstances of the competition. The seed data is the position data and similar for objects placed in the virtual space; in the soccer game, this data is the position data for each of the athlete objects, soccer ball object position data, and similar.

When the server 1 response to the game request signal transmitted by the server query portion 203, the server notification portion 205 processes the corresponding competition to the response from the server 1, based on team data received as the response, and transmits to the server 1 a processing result information including an information identifying the winning team of the competition assigned by the server 1. The winning team notification portion 206 transmits to the server 1 the team data for the winning team in the specified competition, among the plurality of competitions being processed by the game device. The broadcast request portion 207 transmits to the server 1 the broadcast request signal to display the competitions of winning teams produced by the game device, together with the identifier for the game device.

The control portion 181 provided in the satellite terminal 141 comprises a competition image processing portion 208 which generates the game images based on the seed data and displays the images on the corresponding output portion 171. The control portions provided in the other satellite terminals are similarly configured.

The control portion 31 of the server 1 comprises a competition generation portion 71, a competition assignment portion 72, a result acquisition portion 73, and a broadcast information response portion 74. The competition generation portion 71 generates the combination of teams to be made to compete from the plurality of teams with member IDs contained in the winning team table 331, stored in advance in the storage portion 33 of the server 1, and stores this information for each generated competition, in association with member IDs for corresponding teams, as the competition table 332 in the storage portion 33 of the server 1. The competition assignment portion 72, upon receiving information identifying the difference together with the game request signal from the server query portion 203, if the number of unprocessed competitions among the competitions generated by the competition generation portion 71 is greater than the difference, responds to the game device which has transmitted the game request signal with member IDs associated with unprocessed competitions in a number corresponding to the difference.

The result acquisition portion 73 stores the processing result information transmitted by the server notification portion 205, as the result table 333 associated with competitions generated by the competition generation portion 71, in the storage portion 33 of the server 1. Upon receiving the broadcast request signal, the broadcast information response portion 74 identifies the team associated with the identifier which is also received, references the storage portion 33 of the server 1 and selects the competition including the specified team, and responds to the game device which has transmitted the broadcast request signal with the team data for the two teams identified as the opponent teams in the selected competition.

Each of the functional portions in FIG. 14 can be realized either in hardware, or as a program executed by the control portion 31 of the server 1, by the control portion 11 of the game devices, or by a CPU comprised by the satellite control portions 141. When the various functional portions are realized in hardware, the portions need not necessarily be incorporated in the control portion.

According to embodiments of the invention explained above, a system can be introduced which efficiently utilizes the surplus processing capacity of each game device. The system can be introduced easily and inexpensively, without requiring additional equipment. That is, expansion can be achieved without the installation of additional equipment (server) and without incurring additional costs. There is no need for the communication lines between the server and the game devices within the system to be in regular use, so that communication costs during system operation can also be suppressed.

Further, the ghost league, which provides users with new means to enjoy games, can also be conducted. By means of the ghost league, the user can compete with other user outside one's own living area, and the ability of one's own team can easily be measured against others on a national scale. The ghost league requires only game calculations within the game device, so that the user need not take special procedures for entry into the national large-scale event, and need to actually visit the hall at which the national large-scale event is being held; hence a burden on the user is greatly mitigated. Game manufacturers need not conduct the ghost leagues as special events, so that there is the advantage that the ghost league can easily be held.

In these embodiments, the object of play was described as “a team or group comprising a plurality of team members”. That is, the embodiments were explained in terms of competitive games between “teams”. Of course the above-described embodiments can also be applied to competitive games between individuals, as well as between teams.

What is claimed is:

1. A game system, comprising a plurality of game devices, each of which processes a computer game having a gaming element in which a player manages competition with another play object by the player's own play object, and a server connected to the plurality of game devices via a network to enable transmission and reception of information, wherein
each of the plurality of game devices comprising:
a plurality of input and output sets, in each of which an input portion into which instruction for the computer game is input is paired with an output portion on which a game image relating to the computer game is displayed;
a storage portion of the game device in which is stored in advance a first control program to cause display the game image on the output portion; and,
a control portion of the game device which reads the first control program from the storage portion of the game device and performs processing for a prescribed number of the competitions, wherein
the control portion of the game device, by executing the first control program, comprising:
an entry acceptance portion which periodically sets an acceptance interval and accepts a competition request signal input via the input portion by the player during the acceptance interval;
a competition number decision portion which decides the number of competitions based on the competition request signal;
a server query portion which transmits to the server a game request signal together with an information specifying a difference, when the difference between the prescribed number of competitions which the control portion of the game device is capable of processing minus the decided competition number is one or greater;
a seed data generation portion which generates seed data necessary for displaying the circumstance of competition corresponding to the competition request signal as the game image, based on a play object information specifying the play object input via the input portion;
a competition image processing portion which generates the game image based on the seed data and displays on the corresponding output portion; and,
a server notification portion which processes the competition corresponding to a response from the server based on the play object information received as the response, and transmits to the server a processing result information including a winning play object of the competition assigned by the server, when the server responds to the game request signal transmitted by the server query portion;
the server comprising:
a storage portion of the server which stores the plurality of play object information and a second control program; and,
a control portion of the server which reads and executes the second control program, wherein,
the server control portion, by executing the second control program, comprising:
a competition generation portion which generates a combination of the play object to be made to compete from the play object information stored in advance in the storage portion of the server, and stores the combination associated with the corresponding play object information in the storage portion of the server for each of the generated competitions;
a competition assignment portion which responds to the game device which has transmitted the game request signal with the play object information associated with an unprocessed competition of the number of competitions corresponding to the difference, upon receiving from the server query portion the game request signal together with the information specifying the difference, if the unprocessed competition exists among the generated competition; and,
a result acquisition portion which stores the processing result information transmitted by the server notification portion, associated with the generated competition, in the storage portion.

2. The game system according to claim 1, wherein the competition generation portion implements a tournament match by generating the combination of play object which are made to compete, from among a plurality of the winning play objects acquired by the result acquisition portion.

3. The game system according to claim 1, wherein the control portion of the game device, by executing the first control program, comprising:
a winning play object notification portion which transmits to the server a play object information of the play object in a particular competition among the plurality of competitions processed in the game device, wherein
the play object information stored in advance in the storage portion of the server is the play object information transmitted by the winning play object notification portion of the plurality of game devices.

4. The game system according to claim 3, wherein
the game device storage portion storages further an identifier which identifies the game device;
the winning play object notification portion transmits to the server a play object information of the winning play object in association with the identifier;
the game device control portion, by executing the first control program, comprising:
a broadcast request portion which transmits to the server a broadcast request signal to display the competition for the winning play object produced from the game device, together with the identifier for the game device;
the server control portion, by executing the second control program, comprising:
a broadcast information response portion which specifies the play object associated with the identifier which is also received upon reception of the broadcast request signal, references the server storage portion to select the competition including the specified play object, and responds to the game device which has transmitted the broadcast request signal with the play object information for two play objects which are the identified play object and the play object which is the competition opponent in the selected competition.

5. The game system according to claim 4, wherein the game device comprising:
a large-size display device, separate from the output portions included in the input and output sets, the game system, wherein
the competition image processing portion displays the game images generated based on the play object information received as the response, on the large-size display device or on the output portions included in the input and output set not being used for the competition between players among the input and output sets, when the server responds to the broadcast request signal from the broadcast request portion.

6. The game system according to claim 1, wherein
the competition assignment portion transmits the play object information of the same competition to a plurality of the game devices, and
the result acquisition portion stores a processing result information in the storage portion of the server, in association with the generated competition, upon reception of the same processing result information from at least two game devices among the plurality of game devices to which the play object information on the same competition has been transmitted.

7. A game data processing method, in a game system comprising a plurality of game devices each of which process a computer game having a gaming element in which a player manages competition between player's own play object and another play object, and a server which connects to the plurality of game devices via a network to enable transmission and reception of information, wherein the game devices comprising a plurality of input and output sets in each of which an input portion into which instruction for the computer game is input is paired with an output portion on which game image relating to the computer game is displayed, wherein
the game device periodically sets an acceptance interval and accepts a competition request signal input via the input portions from the players during the acceptance interval;
the game device decides the number of competitions based on the competition request signal;
the game device transmits a game request signal to the server together with an information specifying a difference, when the difference of a prescribed number of competitions which can be processed by the game device minus the decided number of competitions is one or greater;
the server generates combination of the play object to be made to compete from the plurality of play objects relating to a play object information stored in a storage portion of the server, and stores the combination associated with the corresponding play object information in the storage portion of the server for each of the generated competitions,
the server responds to the game device which has transmitted the game request signal with the play object information associated with an unprocessed competition of the number of competitions corresponding to the difference, upon receiving from the game device the game request signal together with the information specifying the difference, if the unprocessed competition exists among the generated competitions; and
the game device generates the game image displaying a circumstance of the competition corresponding to the competition request signal, based on the play object information specifying the play object input via the input portions, displays the generated game images on the corresponding output portion, and when the server responds to the game request signal transmitted by the game device, processes the competition corresponding to a response from the server based on the play object information received as the response, and transmits to the server a processing result information including an information specifying a winning play object of the competition assigned by the server.

8. A game device which processes a computer game having a gaming element in which a player manages competition between player's own play object and another play object, comprising:
a plurality of input and output sets, in each of which an input portion into which instruction for the computer game is input is paired with an output portion on which a game image relating to the computer game is displayed;
a storage portion in which is stored in advance a first control program to cause display the game image on the output portion; and,
a control portion which reads the first control program from the storage portion and perform processing for a prescribed number of the competitions, wherein
the control portion, by executing the first control program, comprising:
an entry acceptance portion which periodically sets an acceptance interval and accepts a competition request signal input via the input portion by the player during the acceptance interval;
a competition number decision portion which decides the number of competitions based on the competition request signal;
a server query portion which transmits to the server connected to the game device via a network enabling reception and transmission of information, a game request signal together with an information specifying a difference, when the difference between the prescribed number of competitions which the game device is capable of processing;
a seed data generation portion which generates seed data necessary for displaying the circumstances of competition corresponding to the competition request signal as the game image, based on a play object information specifying the play object input via the input portion;
a competition image processing portion which generates the game image based on the seed data and displays on the corresponding output portion; and
a server notification portion which processes the competition corresponding to a response from the server based on the play object information received as the response, and transmits to the server a processing result information including an information specifying a winning play object of the competition assigned by the server, when the server responds to the game request signal transmitted by the server query portion.

9. A program, which processes a computer game having a gaming element in which a player manages competition between player's own play object and another play object, and causes a game device comprising a plurality of input and output sets in each of which an input portion into which instruction for the computer game is input is paired with an output portion on which game image relating to the computer game is displayed, to function as:
an entry acceptance unit which periodically sets an acceptance interval and accepts a competition request signal input via the input portions from the player during the acceptance interval;
a competition number decision unit which decides the number of competitions based on the competition request signal;
a server query unit which transmits to a server connected via a network to the game device to enable information transmission and reception, a game request signal together with an information specifying a difference, when the difference between the prescribed number of competitions which the game device is capable of processing minus the decided competition number is one or greater,
a seed data generation unit which generates seed data necessary for displaying the circumstances of competition corresponding to the competition request signal as the game image, based on a play object information specifying the play object input via the input portion;
a competition image processing unit which generates the game image based on the seed data and displays the images on the corresponding output portion; and
a server notification unit which processes the competition corresponding to a response from the server based on the play object information received as the response, and transmits to the server a processing result information including an information specifying a winning play object of the competition assigned by the server, when the server responds to the game request signal transmitted by the server query unit.

10. The program according to claim 9, which further causes the game device to function as a winning play object notification unit which transmits to the server a play object information on the winning play object in a specific competition among the plurality of competitions being processed in the game device.

11. The program according to claim 10, wherein
the storage portion storages further an identifier to identify the game device,
the winning play object notification unit transmits to the server play object information of the winning play object in association with the identifier, and wherein
the program causes the game device to further function as a broadcast request unit which transmits to the server, together with the identifier of the game device, a broadcast request signal for display of the competition of the winning play object processed from the game device.

12. The program according to claim 11, wherein
the game device comprising a large-size display device separate from the output portion included in the input and output sets, and
the competition processing unit displays the game images generated based on the play object information received as a response, on the large-size display device or on the output portion included in the input and output sets not being used in the competition among the player among the input and output sets, when the server responds to the broadcast request signal.

13. A game data processing method which processes a computer game having a gaming element in which a player manages competition between player's own play object and another play object, in a game device comprising a plurality of input and output sets in each of which an input portion into which instruction for the computer game is input is paired with an output portion on which game image relating to the computer game is displayed, wherein
the game device periodically sets an acceptance interval and accepts a competition request signal input via the input portions from the player during the acceptance interval;
the game device decides the number of competitions based on the competition request signal;
the game device transmits to a server connected via a network to the game device to enable information transmission and reception, a game request signal together with an information specifying a difference, when the difference between the prescribed number of competitions which the game device is capable of processing minus the decided competition number is one or greater; and
the game device generates the game image displaying a circumstance of the competition corresponding to the competition request signal based on a play object information specifying the play objects input via the input portion, displays the generated image on the corresponding output portion, and, when the server responds to the game request signal transmitted by the game device, processes the competition corresponding to the response from the server based on the play object information received as the response, and transmits to the server a processing result information including an information specifying a winning play object in the competition assigned by the server.
